(19) United States
(12) Patent Application Publication
(10) Pub. No.: US 2013/0015945 A1
(43) Pub. Date: Jan. 17, 2013

(54) FUNCTION SETTING METHOD FOR A CONTROL PANEL OF AN EXERCISE EQUIPMENT

(71) Applicant: Wei-Chun Chang, Taichung City (TW)

(72) Inventor: Wei-Chun Chang, Taichung City (TW)

(73) Assignee: P & F BROTHER INDUSTRIAL CORPORATION, TAICHUNG CITY (TW)

(21) Appl. No.: 13/183,308

(22) Filed: Jul. 14, 2011

(51) Int. Cl. G05B 19/02

(52) U.S. Cl. 340/4.31

(57) ABSTRACT

A function setting method for a control panel of an exercise equipment combines buttons of the control panel with a light source, which makes it easy for the user to tell which button needs to be pressed when the user is setting functions since the button that needs to be pressed has a turned-on backlight, namely, it turns on the button that needs to be pressed to guide the user to press, so as to reduce the possibility of pressing the wrong button and enable the user to use the control panel in a dim environment.

### BACKGROUND OF THE INVENTION

1. Field of the Invention

The present invention relates to a control panel of an exercise equipment, and more particularly to a function setting method for a control panel of an exercise equipment.

2. Description of the Prior Art

Exercise equipments are usually provided with a control panel, and on the control panel are arranged a plurality of buttons for setting different functions. For example, the control panel of a treadmill machine is usually provided with buttons for controlling speed, gradient, time, distance, calories, and etc.

However, there are more and more kinds of exercise equipments coming out onto the market, as a result, the control panel types are becoming more diversified, and relatively, the function setting is also becoming more complicated. The user has to spend much time studying the specification or determine which button to press, and then press the right buttons in predetermined order to set the desired functions. Hence, this is really hard for new users or those who work out in a Gym and want to try different exercise machines. The conventional control panel has the following disadvantages that need to be improved.

Firstly, the control panel is provided with a plurality of buttons and a display light source separated from the buttons. Therefore, it is hard to immediately tell to which button the “on” display light source corresponds, when the user presses the button, so that the user usually presses the wrong buttons.

Secondly, since the display light source is separated from other buttons, and the buttons can't produce light on their own, hence, it is impossible to use the function buttons in a dark environment.

The present invention has arisen to mitigate and/or obviate the afore-described disadvantages.

### SUMMARY OF THE INVENTION

The primary object of the present invention is to provide a function setting method for a control panel of an exercise equipment, which makes it easy for the user to set functions by turning on the backlight of the button that needs to be pressed to guide the user to press.

Another object of the present invention is to provide a function setting method for a control panel of an exercise equipment, which enables the user to use the control panel in a dim environment by turning on the backlight of the button that needs to be pressed to guide the user to press.

To achieve the above objects, a function setting method for a control panel of an exercise equipment in accordance with the present invention comprises the steps of: resetting: turning off all backlights of all buttons on the control panel; unlocking: turning on a backlight of a valid button that needs to be pressed so as to guide a user to press, and the rest buttons are invalid buttons whose backlights are turned off; and judging and setting: judging whether the valid button is pressed, if yes, turning on a backlight of a next button to be pressed, and the rest buttons are invalid buttons and their backlights are turned off, repeating the judging and setting step until all settings are done.

The backlight of the valid buttons can be constant light or flashing light.

### BRIEF DESCRIPTION OF THE DRAWINGS

FIG. 1 is a flow chart showing a function setting method for a control panel of an exercise equipment in accordance with the present invention;

FIG. 2 is an illustrative view in accordance with the present invention showing the status of the control panel during the step of resetting;

FIG. 3 is an illustrative view in accordance with the present invention showing the status of the control panel after the step of unlocking;

FIG. 4 is an illustrative view in accordance with the present invention showing the status of the control panel during the step of judging and setting;

FIG. 5 is another illustrative view in accordance with the present invention showing the status of the control panel during the step of judging and setting;

FIG. 6 is another illustrative view in accordance with the present invention showing the status of the control panel during the step of judging and setting; and

FIG. 7 is another illustrative view in accordance with the present invention showing the status of the control panel during the step of judging and setting.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

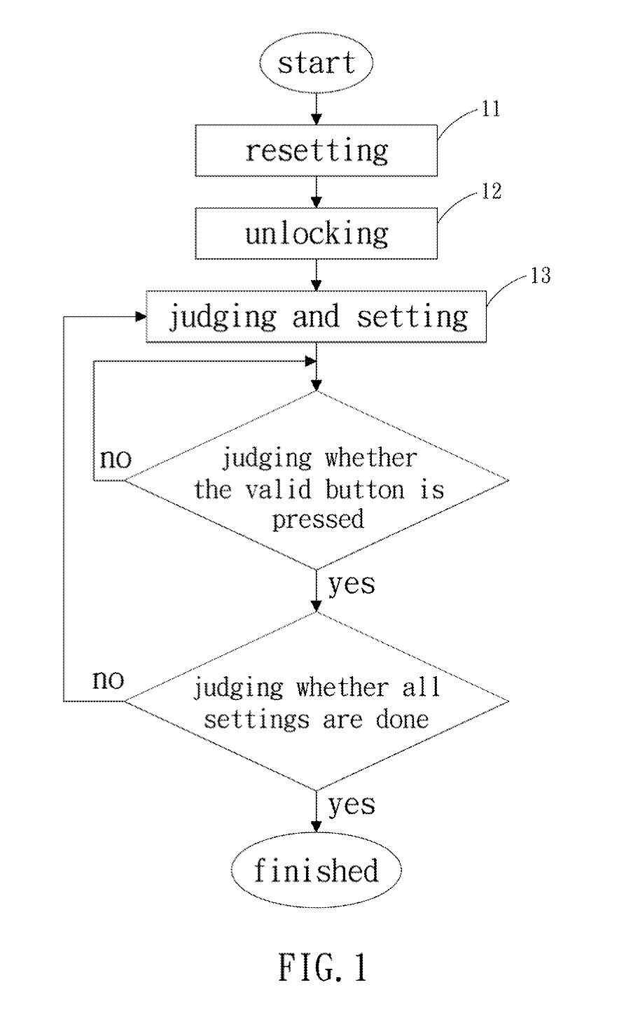

Referring to FIG. 1, a function setting method for a control panel of an exercise equipment comprises the steps of: resetting 11, unlocking 12 and judging and setting 13.

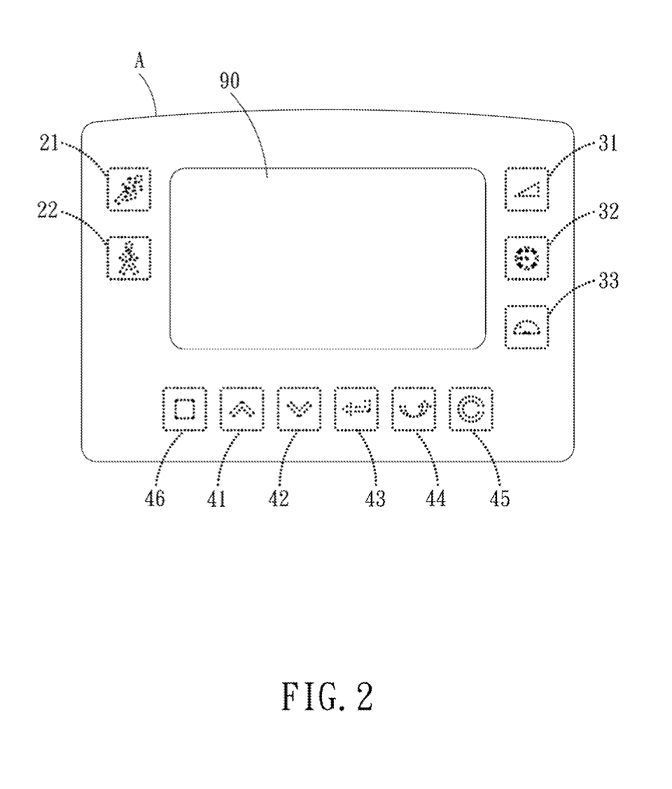

The step of resetting 11 is carried out by pressing the “reset” button or the “power” button to turn off all the buttons' backlights, namely, making all buttons invalid. For example, as shown in FIG. 2, all the buttons on the control panel A are dimed and shown in dot lines. These buttons can be the function buttons corresponding to modes of exercise (for instance, buttons of running mode 21 and jogging 22, etc), gradient button 31, time setting button 32, speed button 33, adjust up button 41, adjust down button 42, input button 43, restore button 44, start button 45, stop button 46, etc.

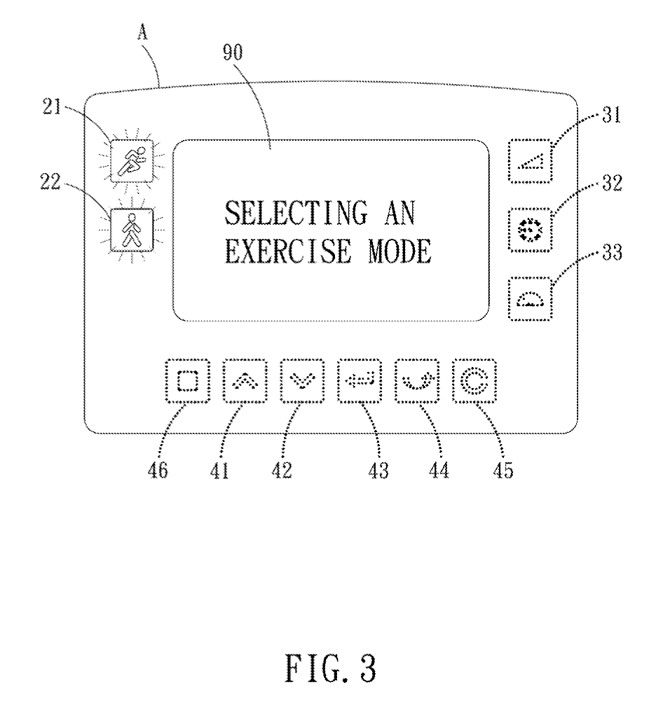

The step of unlocking 12 is to turn on the backlights of the valid buttons that can be pressed, and the rest buttons are invalid and their backlights are turned off, so that the valid buttons with turned-on backlights guide the user to press, wherein only the valid buttons with turned-on backlights can be pressed to set exercise mode, while the invalid buttons with turned-off backlights are unable to set exercise mode. For example, as shown in FIG. 3, the valid buttons 21 and 22 which are for running mode and jogging mode are shown in solid lines, while the invalid buttons (including the gradient button 31, time setting button 32, speed button 33, adjust up button 41, adjust down button 42, input button 43, restore button 44, start button 45, stop button 46) are shown in dot lines.

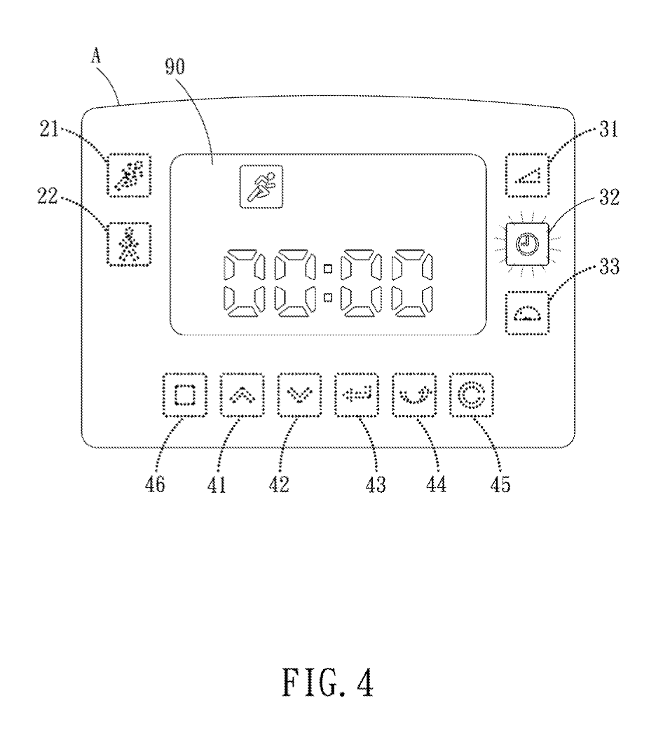

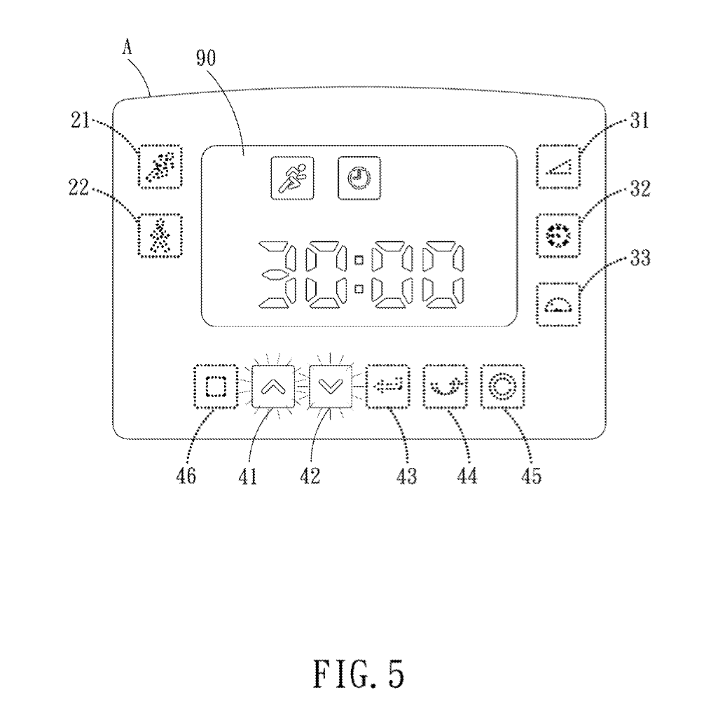

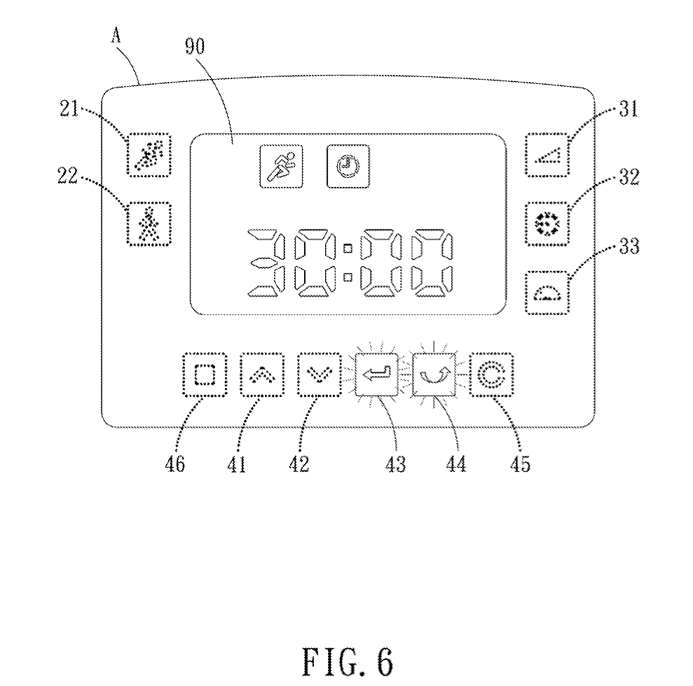

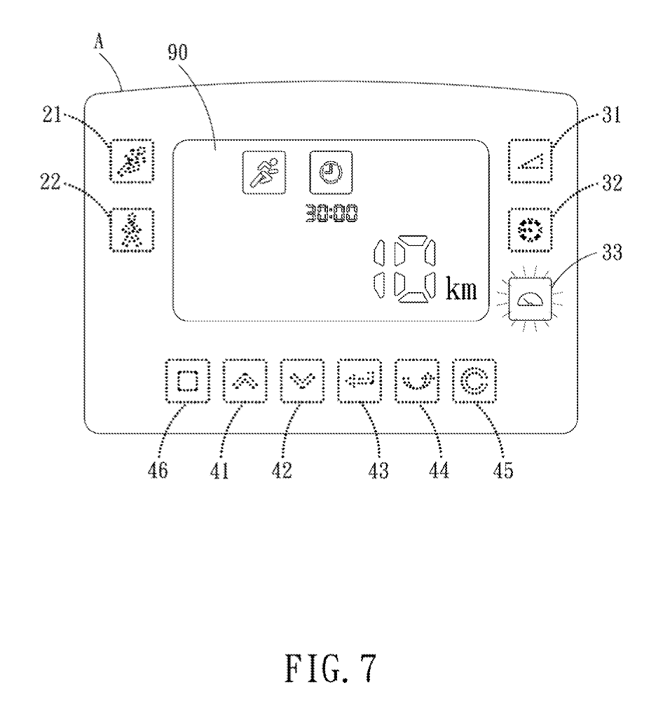

The step of judging and setting 13 is to judge whether the user pressed a valid button or not, if yes, then turn on the backlight of the next valid button to be pressed, while the rest buttons are invalid and their backlights are turned off. The step of judging and setting 13 is repeated until all the settings are done. The judging means to judge whether the user pressed the valid button, if not, the backlight of the valid button keeps turning on and the invalid buttons keep turning off. In this way, the backlight of the next valid button that is designed to be pressed according to the selected exercise mode is turned on to guide the user to press, and the rest buttons are invalid and their backlights are turned off. On top of that, the step of judging and setting 13 also judges whether the selected program corresponding to the pressed button is finished or not after the user pressed the valid button. If yes, the step of judging and setting 13 is finished, or it will be repeated until all settings are done. For example, when the user presses the valid running mode button 21, the judging program makes a judgment, and then, as shown in FIG. 4, the backlight of the next valid to-be-pressed button which is the time setting button 32 is turned on, and the rest buttons are invalid and turned off. After the user presses the valid time setting button 32, the judging program makes a judgment, and then, as shown in FIG. 5, the backlights of the next valid to-be-pressed buttons which are the adjust up button 41 and the adjust down button 42 are turned on, and the rest buttons are invalid and turned off. When the user presses the adjust up button 41 or the adjust down button 42, the judging program makes a judgment, and then, as shown in FIG. 6, the backlights of the next valid to-be-pressed buttons which are the input button 43 and the restore button 44 are turned on, and the rest buttons are invalid and turned off. After the user presses the valid input button 43, the time setting of the running mode is finished. At this moment, the judging program makes a judgment, as shown in FIG. 7, the backlight of the next valid to-be-pressed button which is the speed button 33 is turned on, and thus all the settings of the running mode are finished by repeating the above steps.

It is to be noted that the values to be set during the above steps are displayed on a display unit 90 on the control panel A, and the backlights of the valid buttons are constant lights or flashing lights.

The present invention combines the buttons of the control panel with the light source, which makes it easy for the user to tell which button needs to be pressed when the user is setting functions or values since the button that needs to be pressed has a turned-on backlight, namely, the present invention turns on the button that needs to be pressed to guide the user to press, so as to reduce the possibility of pressing the wrong button and enable the user to use the control panel in a dim environment.

While we have shown and described various embodiments in accordance with the present invention, it is clear to those skilled in the art that further embodiments may be made without departing from the scope of the present invention.

What is claimed is:

1. A function setting method for a control panel of an exercise equipment comprising the steps of:
resetting: turning off all backlights of all buttons on the control panel;
unlocking: turning on a backlight of a valid button that needs to be pressed so as to guide a user to press, and the rest buttons are invalid buttons whose backlights are turned off; and
judging and setting: judging whether the valid button is pressed, if yes, turning on a backlight of a next button to be pressed, and the rest buttons are invalid buttons and their backlights are turned off, repeating the judging and setting step until all settings are done.

2. The function setting method for a control panel of an exercise equipment as claimed in claim 1, wherein the backlight of the valid buttons is constant light or flashing light.
